(19) United States
(12) Patent Application Publication
(10) Pub. No.: US 2026/0175570 A1
(43) Pub. Date: Jun. 25, 2026

(54) VOLTAGE WAVEFORM ADJUSTMENT APPARATUS, PROCESSING METHOD BY THE APPARATUS, AND PROGRAM

(71) Applicant: CANON KABUSHIKI KAISHA, Tokyo (JP)

(72) Inventor: YASUO BAMBA, Tokyo (JP)

(21) Appl. No.: 19/414,913

(22) Filed: Dec. 10, 2025

(30) Foreign Application Priority Data
Dec. 20, 2024 (JP) 2024-225167

(51) Int. Cl. B41J 2/045

(52) U.S. Cl. CPC B41J 2/04588; B41J 2/04508; B41J 2/04581

(57) ABSTRACT

A voltage waveform adjustment apparatus for adjusting a voltage waveform used to drive a first nozzle and a second nozzle each ejecting liquid includes an acquisition unit configured to acquire an amount of displacement representing an amount of shift in an ejection characteristic between the first nozzle and the second nozzle; a storage unit configured to store a first nozzle model, which is a model that estimates a target ejection characteristic, which is the ejection characteristic targeted by a droplet ejected from the second nozzle, and the ejection characteristic of the droplet ejected upon application of the voltage waveform to the first nozzle; and a determination unit configured to determine the voltage waveform to be applied to the second nozzle using the stored first nozzle model based on the acquired amount of displacement and the stored target ejection characteristic.

### BACKGROUND

### Field of the Technology

The disclosure relates to a voltage waveform adjustment apparatus, a processing method by the voltage waveform adjustment apparatus, and a program.

### Description of the Related Art

Piezoelectric inkjet printers, which eject droplets by using piezoelectric elements that deform upon application of voltage, are known. In the piezoelectric printers, the droplets having desired ejection characteristics (an ejection speed, a volume-of-ejection, and so on) are capable of being ejected by arbitrarily changing the shape of a voltage waveform (driving waveform) to be applied to the piezoelectric element. Configuring a liquid ejection head that has many nozzles and that is capable of applying discrete voltage waveforms to the discrete piezoelectric elements disposed for the respective nozzles enables control of the ejection with high accuracy.

“Inkjet” 2nd version issued on Jul. 20, 2018 by Tokyo Denki University Press, supervised by Masahiko Fujii, compiled by The Imaging Society of Japan discloses in detail a method of ejecting droplets using the piezoelectric method.

Japanese Patent Laid-Open No. 2023-176204 discloses a method of determining a voltage waveform candidate having desired ejection characteristics by using a learned model that receives the voltage waveform and that output the ejection characteristics.

The method disclosed in Japanese Patent Laid-Open No. 2023-176204 has the challenge of learning in advance the model that receives the voltage waveform and that output the ejection characteristics (the ejection speed, the volume-of-ejection, and so on). If non-negligible individual differences caused by a manufacturing error or the like exist between the nozzles, it is necessary to learn the model for each nozzle. However, since a larger amount of learning data is required to train the model, it may take time for adjustment.

### SUMMARY

The present disclosure is directed to enable voltage waveform adjustment to be rapidly performed for each nozzle even if non-negligible individual differences exist between the nozzles.

According to an aspect of the present disclosure, there is provided a voltage waveform adjustment apparatus for adjusting a voltage waveform used to drive a first nozzle and a second nozzle each ejecting liquid. The voltage waveform adjustment apparatus includes at least one memory storing a program and further storing a first nozzle model, which is a model that estimates a target ejection characteristic, which is an ejection characteristic targeted by a droplet ejected from the second nozzle, and an ejection characteristic of the droplet ejected upon application of the voltage waveform to the first nozzle; and at least one processor that, upon execution of the stored program, is configured to operate as an acquisition unit configured to acquire an amount of displacement representing an amount of shift in the ejection characteristic between the first nozzle and the second nozzle and a determination unit configured to determine the voltage waveform to be applied to the second nozzle using the stored first nozzle model based on the acquired amount of displacement and the stored target ejection characteristic.

Features of the present disclosure will become apparent from the following description of embodiments with reference to the attached drawings. The following description of embodiments is described by way of example.

### BRIEF DESCRIPTION OF THE DRAWINGS

FIG. 1A illustrates an example of the hardware configuration of a voltage waveform adjustment system according to a first embodiment and FIG. 1B is a schematic diagram of one of multiple nozzles of a liquid ejection head.

FIG. 2 illustrates an example of the functional configuration of a voltage waveform adjustment apparatus according to the first embodiment.

FIG. 3 is a graph illustrating an example of a voltage waveform in the first embodiment.

FIG. 4 illustrates an example of a neural network in the first embodiment.

FIG. 5 is a flowchart indicating a flow of a process performed by the voltage waveform adjustment apparatus according to the first embodiment.

FIG. 6 is a graph indicating an example of the voltage waveforms enabling normal ejection in the first embodiment.

FIG. 7A is a table describing detailed information for each adjustment target nozzle and FIG. 7B is a table indicating the summary of adjustment results.

FIG. 8 illustrates an example of the hardware configuration of the voltage waveform adjustment apparatus and liquid ejection apparatuses according to a second embodiment.

### DESCRIPTION OF THE EMBODIMENTS

Exemplary embodiments of the disclosure will herein be described in detail with reference to the drawings. Configurations described in the following embodiments are only examples and the disclosure is not limited to the illustrated configurations.

### First Embodiment

In a first embodiment, a method of rapidly performing voltage waveform adjustment for each nozzle even if non-negligible individual differences exist between the nozzles is described.

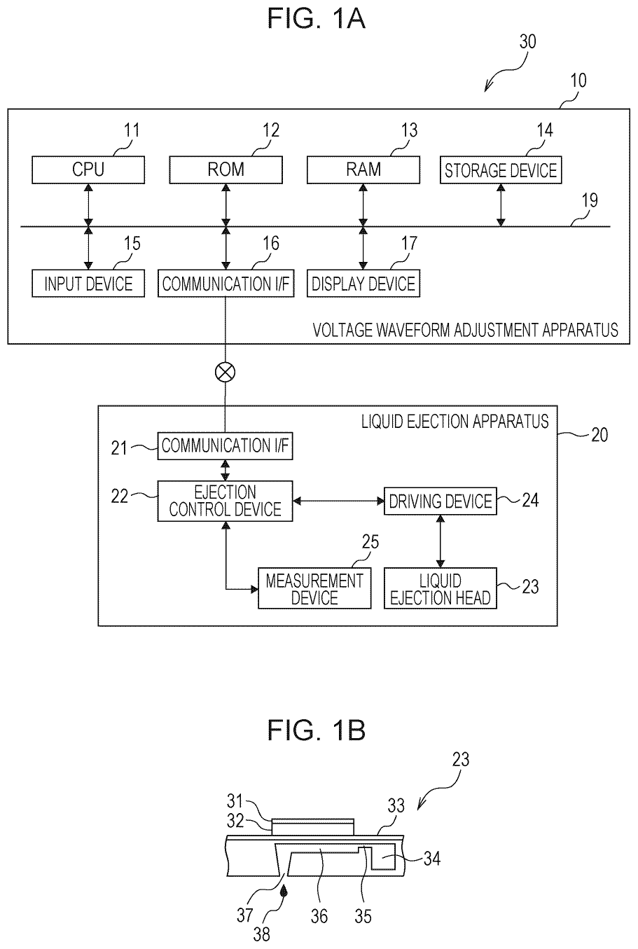

FIG. 1A illustrates an example of the hardware configuration of a voltage waveform adjustment system 30 according to the first embodiment. The voltage waveform adjustment system 30 includes a voltage waveform adjustment apparatus 10 and a liquid ejection apparatus 20.

The voltage waveform adjustment apparatus 10 includes a central processing unit (CPU) 11, a read only memory (ROM) 12, a random access memory (RAM) 13, a storage device 14, an input device 15, a communication interface (I/F) 16, a display device 17, and a system bus 19 as the hardware configuration.

The CPU 11 reads an operating system (OS) and other programs, which are stored in the ROM 12 and the storage device 14, to execute the OS and the programs using the RAM 13 as a working memory and controls the respective components connected to the system bus 19 to perform calculation, logical determination, and so on of various processes. The processes performed by the CPU 11 include information processing of the first embodiment.

The storage device 14 is a hard disk drive, an external storage device, or the like and stores the programs and a variety of data concerning the information processing of the first embodiment.

The input device 15 is an imaging device, such as a camera, and an input device, such as buttons, a keyboard, or a touch panel, used by a user to input instructions.

Although the storage device 14 is connected to the system bus 19 via an interface, such as Serial Advanced Technology Attachment (SATA), and the input device 15 is connected to the system bus 19 via a serial bus, such as a Universal Serial Bus (USB), a detailed description of the connection of the storage device 14 and the input device 15 to the system bus 19 is omitted herein.

The communication I/F 16 communicates with the liquid ejection apparatus 20 described below. The display device 17 is a display.

The liquid ejection apparatus 20 includes hardware elements including a communication I/F 21, an ejection control device 22, a driving device 24, a liquid ejection head 23, and a measurement device 25.

The communication I/F 21 communicates with the voltage waveform adjustment apparatus 10 to receive an ejection instruction from the voltage waveform adjustment apparatus 10 and to transmit a measurement result of liquid ejected to the voltage waveform adjustment apparatus 10.

The ejection instruction from the voltage waveform adjustment apparatus 10 is received via the communication I/F 21 and the ejection control device 22 issues the ejection instruction to the driving device 24 and concurrently issues a measurement instruction to the measurement device 25. The ejection control device 22 operates in coordination with the driving device 24 and the measurement device 25 to cause the measurement device 25 to measure ejection characteristics (an ejection speed, a volume-of-ejection, and so on) of a droplet ejected from the liquid ejection head 23.

The liquid ejection head 23 has multiple nozzles for ejecting the droplets. A nozzle number is allocated to each nozzle for discrimination. The liquid ejection head 23 will be described in detail with reference to FIG. 1B.

FIG. 1B is a schematic diagram of one of the multiple nozzles of the liquid ejection head 23.

An individual electrode 31 is connected to the driving device 24 described below and a voltage waveform is applied from the driving device 24 to the individual electrode 31. One individual electrode 31 is disposed for each nozzle.

A piezoelectric element 32 is an element made of a piezoelectric material and causes deformation (piezoelectric strain) in response to voltage applied to the individual electrode 31.

A vibration plate 33 vibrates in response to the deformation of the piezoelectric element 32 to vary the bulk of a pressure chamber 36. Applying an appropriate voltage waveform to the individual electrode 31 causes vibration of ink and, as a result, a droplet 38 is ejected from an opening of a nozzle 37.

A liquid chamber 34 is a space filled with the ink and supplies the ink to the pressure chamber 36 via an individual supply channel 35. The liquid chamber 34 may be connected to multiple pressure chambers 36 via multiple individual supply channels 35.

Referring back to FIG. 1A, the driving device 24 applies the voltage waveform (a driving signal) to the individual electrode 31 of the liquid ejection head 23 in accordance with the ejection instruction from the ejection control device 22. The driving device 24 is capable of applying the independent voltage waveforms to the multiple individual electrodes 31 of the liquid ejection head 23. The ejection instruction includes the nozzle number and information about the voltage waveform to be applied to the individual electrode 31 of the nozzle. The driving device 24 applies the instructed voltage waveform to the individual electrode 31 of the instructed nozzle in accordance with the ejection instruction.

A process to apply the voltage waveform to the individual electrode 31 of a certain nozzle is simply referred to as “applying the voltage waveform to the nozzle” unless there is any misunderstanding.

The measurement device 25 captures an image of the flying droplet ejected from the nozzle of the liquid ejection head 23 to measure the ejection characteristics of the droplet. The measurement of the droplet is performed by, for example, shooting a state in which the droplet is ejected from the nozzle and flies to a landing surface (not illustrated) by the camera from a side. The measurement device 25 captures consecutive images of a droplet—once at time T and again at time T+ΔT. The measurement device 25 determines the droplet size in the captured images by image processing to calculate the volume-of-ejection of the droplet. The measurement device 25 calculates the droplet ejection speed by dividing the distance the droplet travels during the time interval ΔT by the duration ΔT. The measurement device 25 is adjusted in advance so as to be capable of measuring the droplet from any nozzle of the liquid ejection head 23.

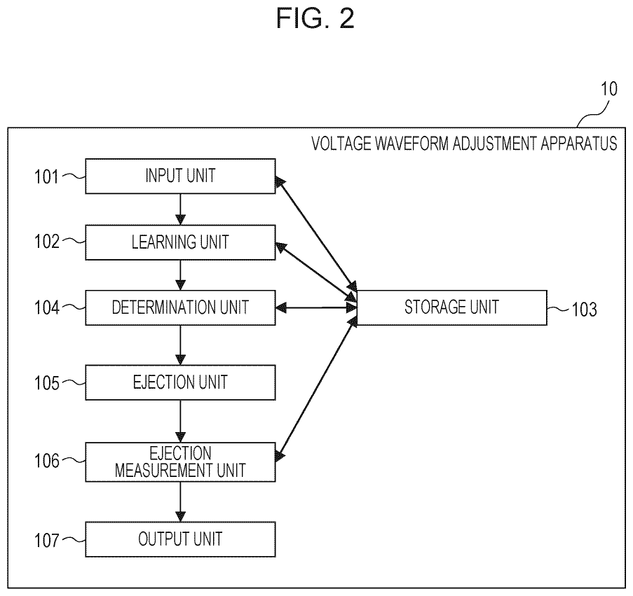

An example of the functional configuration of the voltage waveform adjustment apparatus 10 will now be described with reference to FIG. 2. The functional configuration in FIG. 2 is realized by the CPU 11 that executes the program.

The voltage waveform adjustment apparatus 10 includes an input unit 101, a learning unit 102, a storage unit 103, a determination unit 104, an ejection unit 105, an ejection measurement unit 106, and an output unit 107.

The input unit 101 acquires the nozzle number of a nozzle the voltage waveform of which is to be adjusted (an adjustment target nozzle) and the ejection characteristics (target ejection characteristics) to be realized in each adjustment target nozzle. The ejection characteristics in the first embodiment indicate the volume-of-ejection and the ejection speed of the droplet ejected from the nozzle. Accordingly, the target ejection characteristics are composed of a target volume-of-ejection and a target ejection speed. The volume-of-ejection means the volume of the droplet and is normally represented using a unit pl (picoliter). The ejection speed means the flying speed of the droplet and is normally represented using a unit m/s. The same values may be used as the target ejection characteristics in all the nozzles or different nozzles have different values of the target ejection characteristics.

The ejection characteristics are not limited to the above ones and may include, for example, the values of the radius of the droplet, the ejection angle of the droplet, the degree of sphericity of the droplet, and so on.

Information about the adjustment target nozzle and the target ejection characteristics that are acquired is supplied to the storage unit 103 to be stored in the storage unit 103.

The learning unit 102 acquires learning data composed of a combination of the voltage waveform and the ejection characteristics. In addition, the learning unit 102 learns a model that receives the voltage waveform and that outputs the ejection characteristics.

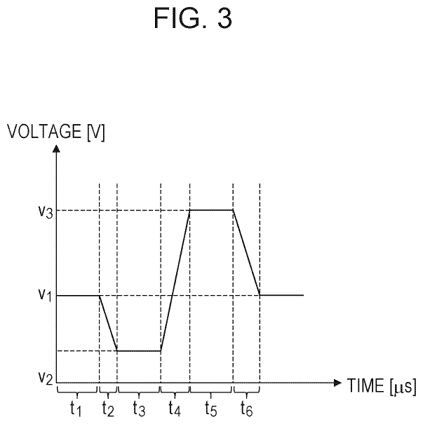

A unipolar type, a bipolar type, and so on are proposed as the shape of the voltage waveform to be applied to the piezoelectric element. FIG. 3 is a graph illustrating an example of the voltage waveform of the bipolar type.

The voltage waveform in FIG. 3 indicates a state in which the voltage sequentially makes a transition in the order of v₁, v₂, v₃, and v₁. Times t₁, t₃, and t₅ represent the times during which the voltages v₁, v₂, and v₃ are held, respectively. A time t₂ represents the time during which the voltage makes a transition from v₁ to v₂. A time t₄ represents the time during which the voltage makes a transition from v₂ to v₃. A time t₆ represents the time during which the voltage makes a transition from v₃ to v₁.

The shape of the voltage waveform of the bipolar type is determined by applying the nine voltage waveform parameters v₁, v₂, v₃, t₁, t₂, t₃, t₄, t₅, and t₆. Not only of the bipolar type but also of other types, the shape of the voltage waveform is generally determined by applying the voltage waveform parameters of an arbitrary number. Although the shape of the voltage waveform is hereinafter described as being the bipolar type, the shape of the voltage waveform is not limited to this.

A column vector formed by arranging the voltage waveform parameters (v₁, v₂, v₃, t₁, t₂, t₃, t₄, t₅, and t₆ here) is simply referred to as the voltage waveform, which is denoted by a letter w, unless there is any misunderstanding.

The learning unit 102 applies any supervised learning method to learn a model that predicts the ejection characteristics from the voltage waveform. A volume-of-ejection prediction model that predicts the volume-of-ejection of the droplet is hereinafter denoted by F(w) and an ejection-speed prediction model that predicts the ejection speed of the droplet is hereinafter denoted by G(w).

A case will now be described as an example, in which a quadratic polynomial model is trained.

In the following description, among the nine voltage waveform parameters, only part of the parameters that are particularly involved in the ejection characteristics of the droplet is varied and the remaining parameters are fixed to certain values. Specifically, (v₂, t₃) are varied and the remaining parameters are fixed to certain values. In this case, the model F(w) that predicts the volume-of-ejection of the droplet is represented by, for example, the following equation:

$$F ( w ) = a \cdot {{v}_{2}}^{2} + b \cdot {{t}_{3}}^{2} + c \cdot {v}_{2} \cdot {t}_{3} + d \cdot {v}_{2} + e \cdot {t}_{3} + f \qquad ( 1 )$$

In the above equation, a, b, c, d, e, and f are learnable parameters. The quadratic polynomial model G(w) that predicts the ejection speed of the droplet is represented in the same manner.

This quadratic polynomial is only an example. For example, among the nine voltage waveform parameters, another combination different from the combination of (v₂, t₃), such as (v₂, t₂), may be varied. In addition, the number of terms may be varied in accordance with increase or decrease in the number of the variable parameters. Furthermore, the terms the contribution ratio of which is known to be low may be deleted.

Next, the learnable parameters a, b, c, d, e, and f described above are learned from the combination of the voltage waveform and the ejection characteristics, which is collected in advance. The learning of the parameters is capable of being performed by calculating the parameters causing the sum of the squared error of the output from the model and the squared error of the ejection characteristics to be minimized using, for example, a least square method. The learning method of the parameters is not limited to the above one. For example, a method, such as ridge regression, that prevents overfitting of the parameters by adding a regularization term to the least square method may be used.

The parameters of the model learned in the learning unit 102 are supplied to the storage unit 103 to be held in the storage unit 103.

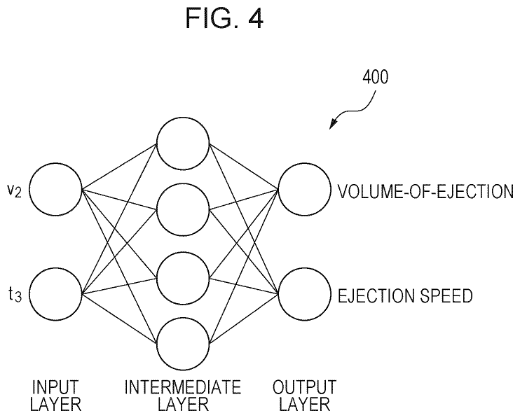

The case in which the quadratic polynomial is used as the model is described above. The model is not limited to this and an arbitrary model, such as a neural network or a decision tree, is applicable. For example, an example of a neural network is illustrated in FIG. 4. A neural network 400 has one intermediate layer. The variable voltage waveform parameters (v₂, t₃ here) are received on an input layer and the ejection characteristics (the volume-of-ejection and the ejection speed here) are output from an output layer. The parameters of the neural network 400 (the weight and the bias of each node) are capable of being learned with a known method, such as an error back-propagation method, using the combination of the voltage waveform and the ejection characteristics, which is collected in advance.

Although the shape of the voltage waveform is described to be determined by applying the voltage waveform parameters of an arbitrary number (nine in the above example), the method of representing the voltage waveform is not limited to this.

For example, a sufficiently short time interval T may be defined and the time series values of the voltages at the respective times, 0, T, 2T, 3T, 4T, . . . , and MT may be used as the voltage waveforms. Here, M is a positive number that is sufficient to cover the total length of the voltage waveforms. When the shape of the voltage waveform is represented in the time series format, a Recurrent Neural Network (RNN) or the like, which is typified by a Long Short-Term Memory (LSTM), may be used as the model.

The storage unit 103 stores the nozzle (the adjustment target nozzle) the voltage waveform of which is to be adjusted and the ejection characteristics (the target ejection characteristics) to be realized at each adjustment target nozzle, which are acquired by the input unit 101. In addition, the storage unit 103 holds the parameters of the model learned by the learning unit 102. Furthermore, the storage unit 103 holds a voltage waveform adjustment result (a combination of the nozzle number, the number of times of adjustment, the voltage waveform, the ejection result, and the result of determination of whether an ejection criterion is achieved) for each adjustment target nozzle.

The determination unit 104 receives the nozzle number and the target ejection characteristics of the adjustment target nozzle from the input unit 101 to determine the voltage waveform to be applied to each adjustment target nozzle so that each adjustment target nozzle achieves the target ejection characteristics. The determined voltage waveform is supplied to the ejection unit 105. This process will be described in detail below.

The ejection unit 105 receives the voltage waveform and the nozzle number of an ejection target nozzle from the learning unit 102 and the determination unit 104 and applies the above voltage waveform to the ejection target nozzle to cause the ejection target nozzle to eject the droplet. This process is realized upon request from the voltage waveform adjustment apparatus 10 to the liquid ejection apparatus 20.

The ejection measurement unit 106 measures the ejection characteristics of the droplet ejected from the ejection target nozzle by the ejection unit 105 to gain the measurement result. This process is realized upon request from the voltage waveform adjustment apparatus 10 to the liquid ejection apparatus 20.

The output unit 107 displays the voltage waveform adjustment result for each adjustment target nozzle in the display device 17, such as the display. Here, the adjustment result includes, for example, the result indicating whether the adjustment of the voltage waveform succeeded for each adjustment target nozzle, the values of the ejection characteristics achieved as the result of the voltage waveform adjustment, the value of the amount (an amount of displacement) indicating how much an adjustment target nozzle A is displaced from a reference nozzle, and so on.

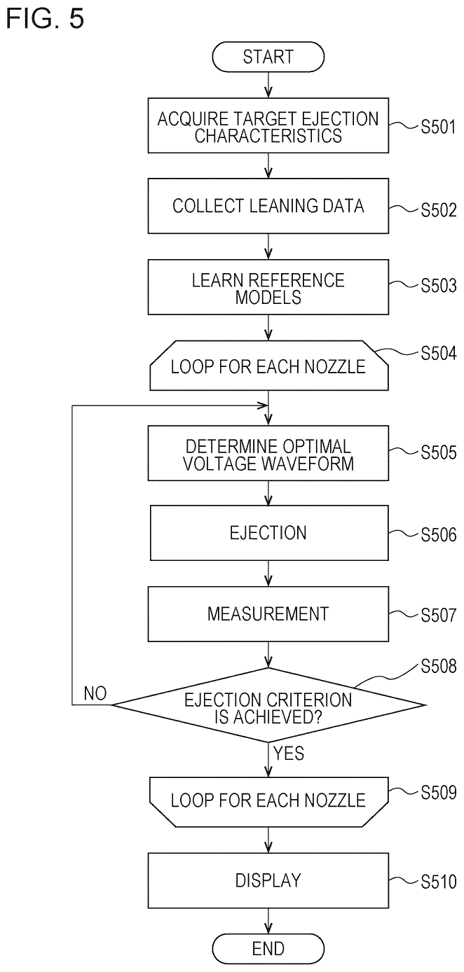

An example of the flow of a voltage waveform adjustment process by the voltage waveform adjustment apparatus 10 according to the first embodiment will now be described with reference to FIG. 5. A processing method by the voltage waveform adjustment apparatus 10 is described here. The voltage waveform adjustment apparatus 10 adjusts the voltage waveform used to drive the reference nozzle and the adjustment target nozzle, both of which eject liquid.

Referring to FIG. 5, in Step S501, the input unit 101 acquires the nozzle number of the nozzle (the adjustment target nozzle) the voltage waveform of which is to be adjusted and the ejection characteristics (the target ejection characteristics) to be realized at each adjustment target nozzle. It is assumed in the following description that the same target ejection characteristics are given at all the adjustment target nozzles for simplicity. The target volume-of-ejection that is given is denoted by Vd_{target} [pl] and the target ejection speed that is given is denoted by V_{target} [m/s].

Information about the adjustment target nozzle and the target ejection characteristics that are acquired is supplied to the storage unit 103 to be stored in the storage unit 103.

In Step S502, the learning unit 102 acquires the learning data composed of the combination of the voltage waveform and the ejection characteristics. An example of a method of acquiring the learning data will now be described.

First, the learning unit 102 determines the nozzle for which the learning data is to be collected. This nozzle is hereinafter referred to as the reference nozzle. The reference nozzle is desirably selected from the nozzles having the average ejection characteristics. Although one of the nozzles disposed near the center of many nozzles is selected as the reference nozzle here, the selection method is not limited to this. For example, preliminary data may be collected from multiple reference nozzle candidates and the nozzle having the most average tendency may be selected as the reference nozzle. Alternatively, multiple nozzles may be selected as the reference nozzles and the average of the ejection characteristics of the multiple nozzles may be used as a representative value.

Next, the learning unit 102 determines the variable parameters, among the voltage waveform parameters, and the movable range of the variable parameters. For example, in the voltage waveform described with reference to FIG. 3, v₂ and t₃ are set as the variable parameters. The movable range of v₂ is set as [v₂ min, v₂ max] and the movable range of t₃ is set as [t₃ min, t₃ max]. At this time, the movable range is desirably determined so as not to depart from the range of the voltage waveform enabling normal ejection. The normal ejection means ideal ejection of one droplet, without a phenomenon, such as satellite (a phenomenon in which small droplets occur, in addition to a main droplet) or mist (a phenomenon in which many very small droplets occur), non-ejection (no droplet is ejected), and so on.

Next, the learning unit 102 varies the variable parameters of the voltage waveform to acquire a voltage waveform list for collecting the learning data. For example, determining v₂ by U (v₂ min, v₂ max) and t₃ by U (t₃ min, t₃ max) generates one voltage waveform. Here, U (a, b) is a function to return one value that is sampled at random from an interval [a, b] in accordance with uniform distribution. Repeating this an N-number times enables the voltage waveform list of a length N to be acquired.

The method of creating the voltage waveform list is not limited to this. For example, it is assumed that v₂ is any of [v₂₁, v₂₂, . . . , v_{2K}] and discrete values of a K-number kinds and t₃ is any of [t₃₁, t₃₂, . . . , t_{3L}] and discrete values of an L-number kinds. In this case, the number of possible voltage waveforms is K×L. Selecting at random the voltage waveforms of an N-number from the voltage waveforms of the K×L number enables the voltage waveform list of the length N to be acquired. If the number of the possible voltage waveforms is sufficiently small, N may be equal to K×L (N=K×L).

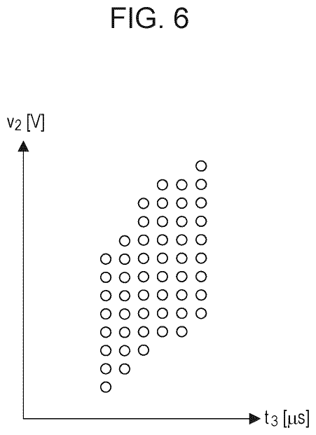

In addition, a case is considered, in which the range of the voltage waveform enabling the normal ejection is known in advance in detail. FIG. 6 is a graph indicating an example of the voltage waveforms enabling the normal ejection. Referring to the graph in FIG. 6, the horizontal axis represents t₃, the vertical axis represents v₂, and the voltage waveforms enabling the normal ejection are represented using white circles. Selecting at random the voltage waveforms of the N-number from the voltage waveforms enabling the normal ejection enables the voltage waveform list of the length N to be acquired.

Next, the learning unit 102 passes the nozzle number of the reference nozzle and each voltage waveform included in the voltage waveform list to the ejection unit 105. The ejection unit 105 sequentially applies the voltage waveforms to the piezoelectric element of the reference nozzle to cause ejection of the droplet. The ejection measurement unit 106 sequentially measures the ejected droplets. This process enables the learning data composed of the combination of the voltage waveform and the ejection characteristics to be acquired.

In Step S503, the learning unit 102 learns the models that receive the voltage waveform and that output the ejection characteristics. As described above, the learning unit 102 acquires the volume-of-ejection prediction model F(w) of the droplet and the ejection-speed prediction model G(w) of the droplet by applying any supervised learning method. The parameters of the learned volume-of-ejection prediction model F(w) and the learned ejection-speed prediction model G(w) are supplied to the storage unit 103 to be held in the storage unit 103.

Since these models are the models that have been learned using the data collected at the reference nozzle, these models are hereinafter referred to as reference models.

Step S505 to Step S508 sandwiched between Step S504 and Step S509 are the voltage waveform adjustment process performed for each adjustment target nozzle. For example, when the adjustment target nozzles are arranged in the order of the nozzle A, a nozzle B, . . . , Step S505 to Step S508 are repeated in a first try, a second try, . . . until the voltage waveform adjustment succeeds for the nozzle A. If the voltage waveform adjustment succeeded halfway, Step S505 to Step S508 are repeated in the first try, the second try, . . . until the voltage waveform adjustment succeeds for the nozzle B. The same applies to the following nozzles. Step S505 to Step S508 are described in detail below on the assumption that the voltage waveforms adjustment is performed for the nozzle A, which is one of the adjustment target nozzles.

Step S505 to Step S508 are the steps based on a nozzle amount-of-displacement method. The nozzle amount-of-displacement method is based on the assumption that “each nozzle of the liquid ejection head 23 is constantly shifted from the reference nozzle in the ejection characteristics by an approximately constant amount”. This amount of shift (difference) is called the amount of displacement. This means that, when a volume-of-ejection prediction model of a nozzle j (the nozzle having a nozzle number j) is denoted by Fj(w) and an ejection-speed prediction model of the nozzle j is denoted by Gj(w), Fj(w) and Gj(w) are approximated by the following expressions:

$$Fj ( w ) \approx F ( w ) + {Vd}_{dj} \qquad ( 2 )$$

$$Gj ( w ) \approx G ( w ) + {V}_{dj} \qquad ( 3 )$$

Here, Vd_{dj} is a scalar value representing the amount of displacement of the volume-of-ejection of the nozzle j and V_{dj} is a scalar value representing the amount of displacement of the ejection speed of the nozzle j. In the following flow, estimation of the amount of displacement of the nozzle using the past ejection results and estimation of an optimal voltage waveform for the nozzle based on the amount of displacement are repeated.

A case in which the first-time voltage waveform adjustment is performed for the nozzle A will now be described. An index concerning the nozzle A is omitted, if possible, for simplicity.

In Step S505 (the first time), the determination unit 104 receives the nozzle number and the target ejection characteristics of the nozzle A from the input unit 101 to determine the voltage waveform (the optimal voltage waveform) to be applied to the nozzle A for the first time. In the first-time voltage waveform adjustment, the amount of displacement of the nozzle A is unknown. Accordingly, for example, a certain voltage waveform that is determined in advance is constantly selected as the optimal voltage waveform. Alternatively, a voltage waveform w in which the ejection characteristics at the reference nozzle are close to the target ejection characteristics may be searched for using the reference models F(w) and G(w) learned in Step S503 to select the voltage waveform w as the optimal voltage waveform. Adopting this method expects achievement of the ejection criterion in the first-time voltage waveform adjustment if the property of the nozzle A is sufficiently close to that of the reference nozzle. Such a method of determining the voltage waveform w is realized by a method of selecting the optimal voltage waveform when the amount of displacement of the nozzle A is set to zero in Step S505 (the second time) described below.

The determination unit 104 supplies the nozzle number of the nozzle A and the voltage waveform to be applied to the nozzle A to the ejection unit 105.

In Step S506 (the first time), the ejection unit 105 receives the nozzle number and the voltage waveform of the nozzle A from the determination unit 104 and applies the voltage waveform to the nozzle indicated by the nozzle number, that is, the nozzle A to cause the nozzle A to eject the droplet.

In Step S507 (the first time), the ejection measurement unit 106 observes the droplet ejected from the nozzle A in Step S506 to measure the ejection characteristics (the volume-of-ejection and the ejection speed) of the droplet. The measured volume-of-ejection is denoted by Vd [pl] and the measured ejection speed is denoted by V [m/s].

In Step S508 (the first time), the determination unit 104 compares the measurement results in Step S507 with the target ejection characteristics acquired in Step S501 to determine whether the ejection criterion is achieved. This determination is capable of being performed by determining allowable errors of the volume-of-ejection and the ejection speed in advance. For example, it is assumed that an absolute allowable error of the volume-of-ejection is determined to be Vd_{allow} [pl] and an absolute allowable error of the ejection speed is determined to be V_{allow} [m/s]. At this time, it is determined that the ejection criterion is achieved if the following conditions are met:

$$\vert Vd - {Vd}_{target} \vert \leq {Vd}_{allow} \qquad ( 4 )$$

$$\vert V - {V}_{target} \vert \leq {V}_{allow}$$

The determination method is not limited to this and another method may be adopted. For example, it is assumed that a relative allowable error of the volume-of-ejection is determined to be Vd_{allow} [dimensionless] and a relative allowable error of the ejection speed is determined to be V_{allow} [dimensionless]. At this time, it may be determined that the ejection criterion is achieved if the following conditions are met:

$$\vert Vd - {Vd}_{target} \vert / {Vd}_{target} \leq {Vd}_{allow} \qquad ( 5 )$$

$$\vert V - {V}_{target} \vert / {V}_{target} \leq {V}_{allow}$$

If the ejection itself is not performed, it is determined that the ejection criterion is not achieved. Also if the ejection is performed but the phenomenon, such as the satellite or the mist, occurs, it may be determined that the ejection criterion is not achieved.

In Step S508 (the first time), the determination unit 104 holds the first-time voltage waveform adjustment result (the combination of the nozzle number, the number of times of adjustment, the voltage waveform, the ejection result, and the result of determination of whether the ejection criterion is achieved) for the nozzle A in the storage unit 103.

If it is determined that the ejection criterion is achieved (YES in Step S508), the process goes to Step S509 to perform the voltage waveform adjustment for the next adjustment target nozzle. If it is determined that the ejection criterion is not achieved (NO in Step S508), the process goes back to Step S505 to perform the second-time voltage waveform adjustment for the nozzle A. A case will now be described, in which the second-time voltage waveform adjustment is performed for the nozzle A.

In Step S505 (the second time), the determination unit 104 receives the nozzle number and the target ejection characteristics of the nozzle A from the input unit 101 and receives the first-time adjustment result of the nozzle A from the storage unit 103. The determination unit 104 determines the voltage waveform to be next applied to the nozzle A based on the above information. This step will now be described.

Next, the determination unit 104 functions as an acquisition unit to calculate (acquire) the amount of displacement of the nozzle A.

Various methods may be used for the calculation of the amount of displacement.

For example, a method is considered, in which estimated values of the ejection characteristics at the reference nozzle are subtracted from the first-time ejection result for the nozzle A to calculate the amount of displacement. An amount-of-displacement of volume-of-ejection Vd_{d} [pl] and an amount-of-displacement of ejection-speed V_{d} [m/s] are calculated according to the following equations, respectively:

$${Vd}_{d} = Vd - {Vd}_{e} \qquad ( 6 )$$

$${V}_{d} = V - {V}_{e} \qquad ( 7 )$$

Here, Vdₑ is an estimated value of the volume-of-ejection at the reference nozzle and Vₑ is an estimated value of the ejection speed at the reference nozzle. These values are given by inputting the optimal voltage waveform selected in Step S505 (the first time) into the reference models F(w) and G(w) learned in Step S503.

The volume-of-ejection Vd and the ejection speed V described above are examples of actually measured values of the ejection characteristics given by applying a first voltage waveform to the adjustment target nozzle A. The estimated-value of volume-of-ejection Vdₑ and the estimated-value of ejection-speed Vₑ described above are examples of the estimated values of the ejection characteristics given by applying the first voltage waveform to the reference models F(w) and G(w), respectively.

The amount-of-displacement of volume-of-ejection Vd_{d} described above is calculated based on the difference between the volume-of-ejection Vd and the estimated-value of volume-of-ejection Vdₑ. The amount-of-displacement of volume-of-ejection Vd_{d} may be calculated by multiplying the difference between the volume-of-ejection Vd and the estimated-value of volume-of-ejection Vdₑ by a certain value smaller than one.

The amount-of-displacement of ejection-speed V_{d} described above is calculated based on the difference between the ejection speed V and the estimated-value of ejection-speed Vₑ. The amount-of-displacement of ejection-speed V_{d} may be calculated by multiplying the difference between the ejection speed V and the estimated-value of ejection-speed Vₑ by a certain value smaller than one.

When the actually measured value given by applying the optimal voltage waveform selected in Step S505 (the first time) to the reference nozzle exists, the amount of displacement may be calculated using the actually measured value. The amount-of-displacement of volume-of-ejection Vd_{d} [pl] and the amount-of-displacement of ejection-speed V_{d} [m/s] are calculated according to the following equations, respectively:

$${Vd}_{d} = Vd - {Vd}_{r} \qquad ( 8 )$$

$${V}_{d} = V - {V}_{r} \qquad ( 9 )$$

Here, Vdᵣ denotes the actually measured value of the volume-of-ejection at the reference nozzle and Vᵣ denotes the actually measured value of the ejection speed at the reference nozzle.

The actually-measured-value of volume-of-ejection Vdᵣ and the actually-measured-value of ejection-speed Vᵣ described above are examples of the actually measured values of the ejection characteristics given by applying the first voltage waveform to the reference nozzle.

The amount-of-displacement of volume-of-ejection Vd_{d} described above is calculated based on the difference between the volume-of-ejection Vd and the actually-measured-value of volume-of-ejection Vdᵣ. The amount-of-displacement of volume-of-ejection Vd_{d} may be calculated by multiplying the difference between the volume-of-ejection Vd and the actually-measured-value of volume-of-ejection Vdᵣ by a certain value smaller than one.

The amount-of-displacement of ejection-speed V_{d} [m/s] described above is calculated based on the difference between the ejection speed V and the actually-measured-value of ejection-speed Vᵣ. The amount-of-displacement of ejection-speed V_{d} [m/s] may be calculated by multiplying the difference between the ejection speed V and the actually-measured-value of ejection-speed Vᵣ by a certain value smaller than one.

Next, the determination unit 104 calculates a volume-of-ejection prediction model F_{A}(w) of the nozzle A and an ejection-speed prediction model G_{A}(w) of the nozzle A from the amounts of displacement. As described above, the volume-of-ejection prediction model F_{A}(w) and the ejection-speed prediction model G_{A}(w) are calculated according to the following equations:

$${F}_{A} ( w ) = F ( w ) + {Vd}_{d} \qquad ( 10 )$$

$${G}_{A} ( w ) = G ( w ) + {V}_{d} \qquad ( 11 )$$

The volume-of-ejection prediction model F_{A}(w) and the ejection-speed prediction model G_{A}(w) described above are examples of an adjustment target nozzle model, which is a model that estimates the ejection characteristics of the droplet ejected upon application of the voltage waveform w to the adjustment target nozzle A.

The determination unit 104 defines the volume-of-ejection prediction model F_{A}(w) and the ejection-speed prediction model G_{A}(w) by adding the amount-of-displacement of volume-of-ejection Vd_{d} and the amount-of-displacement of ejection-speed V_{d} to the reference models F(w) and G(w), respectively.

Next, the determination unit 104 searches for the voltage waveform w in which the volume-of-ejection prediction model F_{A}(w) is close to the target-volume-of-ejection Vd_{target} [pl] and the ejection-speed prediction model G_{A}(w) is close to the target-ejection-speed V_{target} [m/s]. This search is capable of being performed by, for example, searching for the voltage waveform w minimizing the following objective function:

$${( {F}_{A} ( w ) - {Vd}_{target} )}^{2} + {λ ( {G}_{A} ( w ) - {V}_{target} )}^{2} \qquad ( 12 )$$

Here, λ is a value that determines the weights of the volume-of-ejection and the ejection speed. λ is a value that is designed in advance in consideration of the difference in scale between the volume-of-ejection and the ejection speed and the difference in the degree of importance between the volume-of-ejection and the ejection speed. λ may be equal to one (λ=1).

The amount-of-displacement of volume-of-ejection Vd_{d} and the amount-of-displacement of ejection-speed V_{d} described above are examples of the amounts of displacement representing the amounts of shift in the ejection characteristics between the reference nozzle and the adjustment target nozzle A.

The target-volume-of-ejection Vd_{target} and the target-ejection-speed V_{target} described above are examples of the target ejection characteristics, which are the ejection characteristics targeted by the droplet ejected from the adjustment target nozzle A. The ejection characteristics include at least one of the volume-of-ejection and the ejection speed of the droplet ejected from the nozzle.

The volume-of-ejection prediction model F(w) and the ejection-speed prediction model G(w) are examples of reference nozzle models, which are models that estimate the ejection characteristics of the droplet ejected upon application of the voltage waveform to the reference nozzle.

The determination unit 104 determines the voltage waveform w to be applied to the adjustment target nozzle A based on the amount-of-displacement of volume-of-ejection Vd_{d} and the amount-of-displacement of ejection-speed V_{d} described above, the target-volume-of-ejection Vd_{target} and the target-ejection-speed V_{target} described above, and the volume-of-ejection prediction model F(w) and the ejection-speed prediction model G(w).

Specifically, the determination unit 104 searches for the voltage waveform w in which the output values of the volume-of-ejection prediction model F_{A}(w) and the ejection-speed prediction model G_{A}(w) are close to the target-volume-of-ejection Vd_{target} and the target-ejection-speed V_{target}, respectively, to determine the voltage waveform w to be applied to the adjustment target nozzle A.

In search for optimal solution of the voltage waveform w, since the voltage waveform that was selected in the past voltage waveform adjustment flow but did not achieve the ejection criterion is highly likely not to achieve the ejection criterion even if the voltage waveform is selected again, such a voltage waveform may be excluded from the search target.

Alternatively, the determination unit 104 may search for the voltage waveform w in which the estimated volume-of-ejection of the reference model is close to V_{target}−Vd_{d} [pl] and in which the estimated ejection speed of the reference model is close to V_{target}−V_{d} [m/s]. This search is capable of being performed by, for example, searching for the voltage waveform w minimizing the following objective function:

$${( F ( w ) - ( {Vd}_{target} - {Vd}_{d} ) )}^{2} + {λ ( G ( w ) - ( {V}_{target} - {V}_{e} ) )}^{2} \qquad ( 13 )$$

The determination unit 104 searches for the voltage waveform w in which the output values of the reference models F(w) and G(w) are close to the values resulting from subtracting the amount-of-displacement of volume-of-ejection Vd_{d} and the amount-of-displacement of ejection-speed V_{d} from the target-volume-of-ejection Vd_{target} and the target-ejection-speed V_{target}, respectively, to determine the voltage waveform w to be applied to the adjustment target nozzle A.

Since the two methods described above are equivalent, either method may be adopted.

If the minimum value of the objective function is capable of being analytically calculated, the optimal voltage waveform w is also capable of being analytically obtained. The voltage waveform w is searched for using an arbitrary method otherwise. An example of this will now be described.

If the range of the voltage waveform enabling the normal ejection is known in advance, as indicated in FIG. 6, and the range is sufficiently narrow, the voltage waveform w is capable of being fully searched for within the range to determine the voltage waveform having the minimum value of the objective function as the optimal voltage waveform. If the range of the voltage waveform w is too wide to perform the full-search, the optimal voltage waveform w is capable of being efficiently searched for using a known method, such as a grid-search method, a random search method, a Nelder-Mead method, or a Bayesian optimization method. In this case, if the voltage waveform w making the value of the objective function smaller than a certain value is found, the search may be terminated halfway.

The method of searching for the optimal voltage waveform in a frame of single-purpose optimization in which the optimization is performed for a single objective function is described above. The method is not limited to this. For example, the two objective functions: the objective function concerning the volume-of-ejection and the objective function concerning the ejection speed may be defined to search for the optimal voltage waveform in a frame of multi-purpose optimization in which the optimization is performed for the two objective functions. Since multiple optimal voltage waveform candidates are generally acquired in the multi-purpose optimization, one voltage waveform is preferably selected in accordance with any criterion.

Since Step S506 (the second time), Step S507 (the second time), and Step S508 (the second time) are similarly performed as in Step S506 (the first time), Step S507 (the first time), and Step S508 (the first time), respectively, description of Step S506 (the second time), Step S507 (the second time), and Step S508 (the second time) is omitted herein.

A case will be described, in which the ejection criterion is not continuously achieved an N-number times from the first time to the N-th time for the nozzle A and the N+1-th-time voltage waveform adjustment is performed for the nozzle A.

In Step S505 (the N+1-th time), the determination unit 104 receives the nozzle number and the target ejection characteristics of the nozzle A from the input unit 101 and receives the adjustment results from the first time to the N-th time of the nozzle A from the storage unit 103. The determination unit 104 determines the voltage waveform to be next applied to the nozzle A based on the above information. This step will now be described.

The determination unit 104 calculates the amount (the amount of displacement) indicating how much the nozzle A is shifted from the reference nozzle. The calculation of the amount of displacement is capable of being performed by calculating an average, a median, a trimmed mean, a weighted moving average, an exponentially smoothed moving average, or the like of the respective amounts of displacement acquired from the first-time ejection to the Nth-time ejection. For example, the case in which the average is used will be described. The amount-of-displacement of volume-of-ejection Vd_{d} [pl] and the amount-of-displacement of ejection-speed V_{d} [m/s] are calculated according to the following equations:

$${Vd}_{d} = \sum ( {Vd}_{i} - {Vd}_{ei} ) / N \qquad ( 14 )$$

$${V}_{d} = \sum ( {V}_{i} - {V}_{ei} ) / N \qquad ( 15 )$$

Here, an index i means the result of the i-th-time voltage waveform adjustment. Specifically, the following meanings are defined:
Vdᵢ [pl]: the volume-of-ejection measured in Step S507 (the i-th time)
Vᵢ [m/s]: the ejection speed measured in Step S507 (the i-th time)
Vdₑᵢ [pl]: the estimated value of the volume-of-ejection resulting from inputting the voltage waveform selected in Step S505 (the i-th time) into the reference model F(w) learned in Step S503
Vₑᵢ [m/s]: the estimated value of the ejection speed resulting from inputting the voltage waveform selected in Step S505 (the i-th time) into the reference model G(w) learned in Step S503

A summation sign Σ denotes summation when i moves from 1 to N

As described above, when the amounts-of-ejection Vdᵢ and the ejection-speeds Vᵢ of the N number (N is an integer greater than or equal to two), which represent the amounts of shift in the ejection characteristics between the reference nozzle and the adjustment target nozzle A, are acquired based on the different voltage waveforms of the N number, the determination unit 104 calculates the amount-of-displacement of volume-of-ejection Vd_{d} and the amount-of-displacement of ejection-speed V_{d} based on at least one of the average, the median, the trimmed mean, the weighted moving average, and the exponentially smoothed moving average of the amounts-of-ejection Vdᵢ and the ejection-speeds Vᵢ of the N number, respectively.

Although the calculation of the amounts of displacement is performed based on the estimated values of the ejection characteristics at the reference nozzle in the example, the calculation of the amounts of displacement may be performed based on the actually measured values of the ejection characteristics at the reference nozzle, as described above in Step S505 (the second time).

Since the amounts of displacement are calculated using all of the past voltage waveform adjustment results, it is expected that the accuracy of the amounts of displacement is gradually increased as the adjustment is repeated.

Since the step after the amounts of displacement are calculated is the same as in Step S505 (the second time), description of the step after the amounts of displacement are calculated is omitted herein.

In the flowchart in FIG. 5, the voltage waveform adjustment process from Step S505 to Step S508 is repeated until the actual ejection from the nozzle A meets the ejection criterion. However, the maximum number of trials of the voltage waveform adjustment process may be determined in advance and, if the voltage waveform meeting the ejection criterion is not achieved after the maximum number of trials, the process may be terminated halfway. In this case, the determination unit 104 may hold one voltage waveform having the minimum value of the objective function, among the past voltage waveforms that were tried, in the storage unit 103 as a representative voltage waveform.

After the voltage waveform adjustment is completed for all the adjustment target nozzles, the process goes to Step S510.

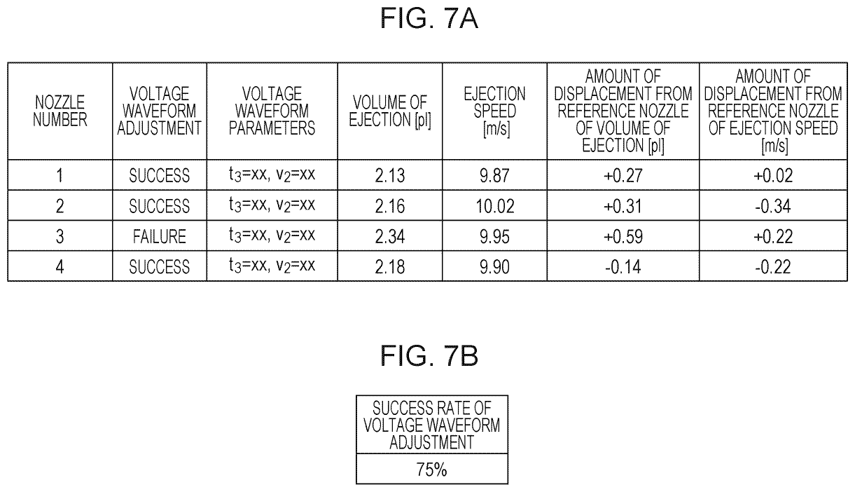

In Step S510, the output unit 107 displays the adjustment results of the voltage waveform for the respective adjustment target nozzles in the display device 17, such as the display. An example of the display of the adjustment results is indicated in FIG. 7A and FIG. 7B.

FIG. 7A is a table describing detailed information for each adjustment target nozzle. In the table in FIG. 7A, the four adjustment target nozzles having the nozzle number 1 to the nozzle number 4 are indicated and, among the four adjustment target nozzles, the nozzle of the nozzle number 3 failed in adjustment and the remaining three nozzles succeeded in adjustment. The voltage waveform parameters when the voltage waveform adjustment succeeded are described in the column of the voltage waveform parameters if the voltage waveform adjustment succeeded, and the voltage waveform parameters that are most close to the target ejection characteristics are described in the column of the voltage waveform parameters if the voltage waveform adjustment failed.

The output unit 107 performs control so as to display the success or the failure of the voltage waveform adjustment, the voltage waveform parameters, the volume-of-ejection, the ejection speed, the amount of displacement from the reference nozzle of the amount of displacement, and

the amount of displacement from the reference nozzle of the ejection speed for each nozzle number. The output unit 107 functions as a control unit, which performs control so as to display information for identifying the nozzles succeeded in the voltage waveform adjustment in the determination by the determination unit 104 and the nozzles failed in the voltage waveform adjustment in the determination by the determination unit 104.

FIG. 7B is a table indicating the summary of the adjustment results. The output unit 107 performs control so as to display the success rate of the voltage waveform adjustment for all the nozzles.

Displaying the adjustment results of the nozzles enable the user to know the success rate of the voltage waveform adjustment, the nozzle number failed in the voltage waveform adjustment, and so on.

The display method is not limited to the above one. For example, the shape of the voltage waveform may be displayed as a graph.

The voltage waveform adjustment system 30 in FIG. 1A includes the voltage waveform adjustment apparatus 10 and the liquid ejection apparatus 20. The liquid ejection apparatus 20 includes the liquid ejection head 23 having the nozzles each ejecting the droplet upon application of the voltage waveform. The voltage waveform adjustment apparatus 10 transmits the ejection instruction to the liquid ejection apparatus 20 and receives the measurement result from the liquid ejection apparatus 20 to adjust the voltage waveforms to be applied to the nozzles of the liquid ejection head 23 in the liquid ejection apparatus 20.

The example of the flow of the voltage waveform adjustment process by the voltage waveform adjustment apparatus 10 according to the first embodiment is described above. As described above, the voltage waveform adjustment apparatus 10 of the first embodiment is capable of rapidly performing the voltage waveform adjustment for each nozzle even if non-negligible individual differences exist between the nozzles.

However, the flow of the voltage waveform adjustment process is not limited to the above one and various modifications are available. The modifications will now be described.

### First Modification

The method of sequentially adjusting the adjustment target nozzles is adopted in the first embodiment. The voltage waveform adjustment is not limited to this method and another method may be adopted. For example, for the first time, the first voltage waveform is determined for each adjustment target nozzle to sequentially perform the ejection and the measurement for each adjustment target nozzle. Next, for the second time, the next voltage waveforms are determined only for the adjustment target nozzles that did not meet the ejection criterion in the first-time voltage waveform adjustment to sequentially perform the ejection and the measurement. The same applies to the subsequent voltage waveform adjustments.

### Second Modification

The amount-of-displacement of volume-of-ejection Vd_{d} [pl] and the amount-of-displacement of ejection-speed V_{d} [m/s] are calculated according to the following equations in the first embodiment:

$${Vd}_{d} = \sum ( {Vd}_{i} - {Vd}_{ei} ) / N \qquad ( 16 )$$

$${V}_{d} = \sum ( {V}_{i} - {V}_{ei} ) / N \qquad ( 17 )$$

The amount of displacement is a value the accuracy of which is expected to be gradually increased as the adjustment is repeated. Conversely, the amount of displacement determined only from the voltage waveforms of a small number may be reduced in reliability. Accordingly, a coefficient h(N) that is determined based on a number-of-trials N is multiplied according to the following equations to define the amounts of displacement:

$${Vd}_{d} = h ( N ) \cdot \sum ( {Vd}_{i} - {Vd}_{ei} ) / N \qquad ( 18 )$$

$${V}_{d} = h ( N ) \cdot \sum ( {V}_{i} - {V}_{ei} ) / N \qquad ( 19 )$$

The coefficient h(N) is a function that monotonically increases in accordance with the value of the number-of-trials N and that is converged to one when N→∞. For example, the coefficient h(N) is defined according to the following equation:

$$h ( N ) = N / ( N + 1 ) \qquad ( 20 )$$

Introducing such a coefficient has the effect of preventing the amount of displacement determined only from the voltage waveforms of a small number from having an extreme value.

The amount-of-displacement of volume-of-ejection Vd_{d} described above is calculated based on the difference between the volume-of-ejection Vdᵢ and the estimated-value of volume-of-ejection Vdₑᵢ, the number-of-trials N, and the coefficient h(N) smaller than one.

The amount-of-displacement of ejection-speed V_{d} described above is calculated based on the difference between the ejection-speed Vᵢ and the estimated-value of ejection-speed Vₑᵢ, the number-of-trials N, and the coefficient h(N) smaller than one.

### Third Modification

The configuration is adopted in the first embodiment, in which Step S502 to collect the learning data and Step S503 to learn the regression model are performed each time the voltage waveform adjustment is performed. However, a configuration may be adopted in which Step S502 and Step S503 are not performed each time the voltage waveform adjustment is performed. For example, Step S502 and Step S503 are applied to a certain reference nozzle of a certain liquid ejection head 23 and the parameters of the regression model are held in the storage unit 103. The parameters of the regression model are used also in the voltage waveform adjustment of the other liquid ejection heads 23.

Adopting such a configuration enables the processing process of the voltage waveform adjustment to be simplified.

### Fourth Modification

The configuration is adopted in the first embodiment, in which the voltage waveform adjustment is performed for the nozzles of the liquid ejection head 23 without distinction. However, a configuration may be adopted in which the nozzles are divided into certain groups, the reference nozzle is determined for each group, and the amount of displacement from the reference nozzle is calculated to adjust the voltage waveform.

For example, a case is considered in which the nozzles are two-dimensionally arranged (for example, in a grid pattern or a triangular grid pattern) in the liquid ejection head 23. If the nozzles of different columns are known to have different properties, the nozzles are divided into groups of the respective columns. One nozzle is independently selected from each group as the reference nozzle and the remaining nozzles are set as the adjustment target nozzles. The voltage waveform adjustment is performed for the adjustment target nozzles using the same method as in the first embodiment.

Adopting such a configuration increases the efficiency and the accuracy of the voltage waveform adjustment.

### Fifth Modification

Also in a fifth modification, the nozzles are divided into certain groups, as in the fourth modification of the first embodiment. However, although non-negligible individual difference exists between the nozzles in each group in the fourth modification of the first embodiment, it is assumed in the fifth modification that the individual difference between the nozzles in each group is negligibly small. Accordingly, if one representative nozzle is selected from each group and the waveform adjustment is performed for a representative nozzle group, it is supposed that the waveform adjustment for all the nozzles belonging to all the groups is concurrently performed.

The voltage waveform adjustment apparatus 10 selects one representative nozzle from each group. The voltage waveform adjustment apparatus 10 determines one nozzle in the representative nozzles as the reference nozzle and determines the remaining nozzles as the adjustment target nozzles. The voltage waveform adjustment apparatus 10 performs the voltage waveform adjustment for the adjustment target nozzles using the same method as in the first embodiment. The nozzles belonging to each group share the voltage waveform determined for the representative nozzle of the corresponding group.

Adopting such a configuration increases the efficiency of the voltage waveform adjustment.

### Sixth Modification

The configuration is adopted in the first embodiment, in which the voltage waveform adjustment results are stored in the storage unit 103 in the voltage waveform adjustment apparatus 10. However, the configuration of the voltage waveform adjustment apparatus 10 is not limited to this.

For example, a configuration may be adopted in which the liquid ejection apparatus 20 additionally includes a storage unit and the voltage waveform adjustment results are stored in this storage unit. Adopting such a configuration enables the liquid ejection apparatus 20 to apply the adjusted voltage waveform to each nozzle without communication with the voltage waveform adjustment apparatus 10 after the voltage waveform adjustment process by the voltage waveform adjustment apparatus 10 is terminated.

### Seventh Modification

The configuration is adopted in the first embodiment, in which the voltage waveform adjustment apparatus 10 and the liquid ejection apparatus 20 are separate apparatuses. However, the configuration of the apparatuses is not limited to this.

For example, the measurement device in the liquid ejection apparatus 20 may be made independent to be a separate device. Alternatively, for example, the voltage waveform adjustment apparatus 10 and the liquid ejection apparatus 20 may be integrated as one apparatus.

### Second Embodiment

In a second embodiment, a method of performing the voltage waveform adjustment for each liquid ejection head in multiple liquid ejection heads will be described. Description of the same points as in the first embodiment is omitted and only points different from the first embodiment will be described.

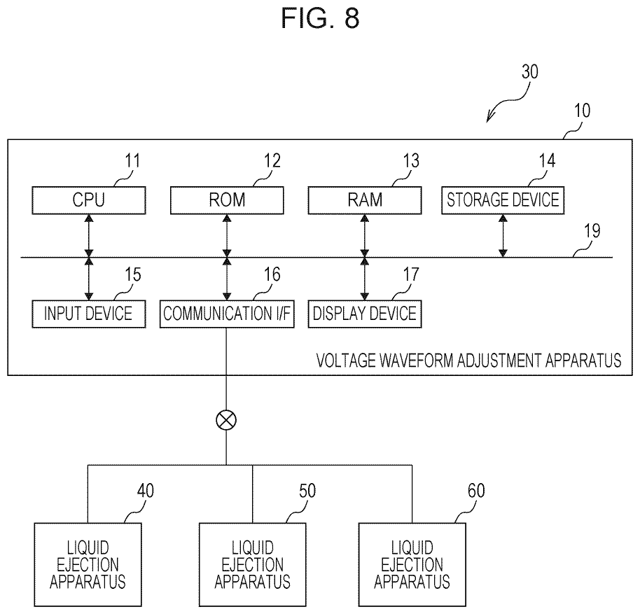

FIG. 8 illustrates the hardware configuration of the voltage waveform adjustment system 30 according to the second embodiment. The voltage waveform adjustment system 30 includes the voltage waveform adjustment apparatus 10 and multiple liquid ejection apparatuses 40, 50, and 60.

The voltage waveform adjustment apparatus 10 is connected to the multiple liquid ejection apparatuses 40, 50, and 60 and is capable of performing the voltage waveform adjustment for each liquid ejection head in each of the liquid ejection apparatuses 40, 50, and 60. The liquid ejection apparatuses 40, 50, and 60 have the same configuration as that of the liquid ejection apparatus 20 of the first embodiment.

It is assumed in the second embodiment that the individual differences between the nozzles are negligibly small in any liquid ejection head. It is also assumed that non-negligible individual differences exist between the liquid ejection heads. Accordingly, if one representative nozzle is selected from each liquid ejection head and the waveform adjustment is performed for the representative nozzle group, it is supposed that the waveform adjustment for all the nozzles belonging to all the liquid ejection heads is concurrently performed.

It is assumed here that three liquid ejection heads exist.

The storage unit 103 in the voltage waveform adjustment apparatus 10 is capable of holding the voltage waveform adjustment result (the combination of the nozzle number, the number of times of adjustment, the voltage waveform, the ejection result, and the result of determination of whether the ejection criterion is achieved) for each adjustment target nozzle in each of the multiple liquid ejection apparatuses 40, 50, and 60 that are connected to the voltage waveform adjustment apparatus 10.

The voltage waveform adjustment apparatus 10 selects one liquid ejection head from the three liquid ejection heads as a reference liquid ejection head. The voltage waveform adjustment apparatus 10 selects the representative nozzle from the reference liquid ejection head as the reference nozzle. The voltage waveform adjustment apparatus 10 performs the collection of the learning data (in the same manner as in Step S502 of the first embodiment) and the learning of the regression model (in the same manner as in Step S503 of the first embodiment) using the reference nozzle.

Next, the voltage waveform adjustment apparatus 10 selects one representative nozzle in each of the remaining two liquid ejection heads that were not selected as the reference liquid ejection head to perform the voltage waveform adjustment process (Step S505 to Step S508 in the first embodiment) for the selected nozzles.

The nozzles belonging to each liquid ejection head share the voltage waveform determined for the representative nozzle of the corresponding liquid ejection head.

The example of the flow of the voltage waveform adjustment process by the voltage waveform adjustment apparatus 10 according to the second embodiment is described above. As described above, the voltage waveform adjustment apparatus 10 of the second embodiment is capable of rapidly performing the voltage waveform adjustment for each liquid ejection head even if non-negligible individual differences exist between the liquid ejection heads.

However, the flow of the voltage waveform adjustment process is not limited to the above one and various modifications are available. One modification will now be described.

### First Modification

Although it is assumed in the second embodiment that the individual differences between the nozzles are negligibly small in any liquid ejection head, it is assumed in a first modification that the individual differences between the nozzles are not negligible in any liquid ejection head. In other words, the individual differences exist between the liquid ejection heads and the individual differences also exit between the nozzles of each liquid ejection head.

In this case, the voltage waveform adjustment apparatus 10 selects one nozzle belonging to any of the three liquid ejection heads as the reference nozzle. The voltage waveform adjustment apparatus 10 performs the collection of the learning data (in the same manner as in Step S502 of the first embodiment) and the learning of the regression model (in the same manner as in Step S503 of the first embodiment) using the reference nozzle.

Next, the voltage waveform adjustment apparatus 10 performs the voltage waveform adjustment process (in the same manner as in Step S505 to Step S508 of the first embodiment) for all the nozzles other than the reference nozzle.

In the first modification, it is possible to rapidly perform the voltage waveform adjustment for each nozzle even if non-negligible individual differences exist between all the nozzles of all the liquid ejection heads.

Although the embodiments of the disclosure are described above, the disclosure is not limited to the specific embodiments. It will be recognized and understood that various changes and modifications may be made within the scope of the disclosure described in the claims.

According to the first and second embodiments, it is possible to rapidly perform the voltage waveform adjustment for each nozzle even if non-negligible individual differences exist between the nozzles.

### Other Embodiments

The disclosure may be realized by a process in which a program realizing one or more functions of the above embodiments is supplied to a system or an apparatus via a network or a storage medium and one or more processors in the computer of the system or the apparatus reads out the program for execution. The disclosure may be realized by a circuit (for example, an application specific integrated circuit (ASIC) realizing one or more functions.

The embodiments described above are only examples for embodying the disclosure and the technical scope of the disclosure is not limitedly interpreted by the embodiments.

In other words, the disclosure is capable of being embodied in various modes without departing from the technical idea or the main features of the disclosure.

According to the disclosure, it is possible to rapidly perform the voltage waveform adjustment for each nozzle even if non-negligible individual differences exist between the nozzles.

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-225167, filed Dec. 20, 2024, which is hereby incorporated by reference herein in its entirety.

What is claimed is:

1. A voltage waveform adjustment apparatus for adjusting a voltage waveform used to drive a first nozzle and a second nozzle each ejecting liquid, the voltage waveform adjustment apparatus comprising:
at least one memory storing a program and further storing
a first nozzle model, which is a model that estimates a target ejection characteristic, which is an ejection characteristic targeted by a droplet ejected from the second nozzle, and
an ejection characteristic of the droplet ejected upon application of the voltage waveform to the first nozzle; and
at least one processor that, upon execution of the stored program, is configured to operate as:
an acquisition unit configured to acquire an amount of displacement representing an amount of shift in the ejection characteristic between the first nozzle and the second nozzle; and
a determination unit configured to determine the voltage waveform to be applied to the second nozzle using the stored first nozzle model based on the acquired amount of displacement and the stored target ejection characteristic.

2. The voltage waveform adjustment apparatus according to claim 1,
wherein the amount of displacement is calculated based on a difference between an actually measured value of the ejection characteristic given by applying a first voltage waveform to the second nozzle and an estimated value of the ejection characteristic given by applying the first voltage waveform to the first nozzle.

3. The voltage waveform adjustment apparatus according to claim 1,
wherein the amount of displacement is calculated based on a difference between an actually measured value of the ejection characteristic given by applying a first voltage waveform to the second nozzle and an actually measured value of the ejection characteristic given by applying the first voltage waveform to the first nozzle.

4. The voltage waveform adjustment apparatus according to claim 1,
wherein the ejection characteristic includes at least one of a volume-of-ejection and an ejection speed of the droplet ejected from the nozzle.

5. The voltage waveform adjustment apparatus according to claim 1,
wherein the determination unit determines a second nozzle model, which is a model that estimates the ejection characteristic of the droplet ejected upon application of the voltage waveform to the second nozzle, by adding the amount of displacement to the first nozzle model, and
wherein the determination unit searches for a voltage waveform in which an output value from the second nozzle model is close to the target ejection characteristic to determine the voltage waveform to be applied to the second nozzle.

6. The voltage waveform adjustment apparatus according to claim 1,
wherein the determination unit searches for a voltage waveform in which an output value from the first nozzle model is closest to a value resulting from subtracting the amount of displacement from the target ejection characteristic to determine the voltage waveform to be applied to the second nozzle.

7. The voltage waveform adjustment apparatus according to claim 1,
wherein, when the amounts of displacement of an N-number, N being an integer greater than or equal to two, which represent the amounts of shift in the ejection characteristic between the first nozzle and the second nozzle, are acquired based on the different voltage waveforms of the N-number, the determination unit calculates the amount of displacement based on any or all of an average, a median, a trimmed mean, a weighted moving average, and an exponentially smoothed moving average of the amounts of displacement of the N number.

8. The voltage waveform adjustment apparatus according to claim 2,
wherein the amount of displacement is calculated by multiplying the difference between the actually measured value of the ejection characteristic given by applying the first voltage waveform to the second nozzle and the estimated value of the ejection characteristic given by applying the first voltage waveform to the first nozzle by a predetermined value smaller than one.

9. The voltage waveform adjustment apparatus according to claim 3,
wherein the amount of displacement is calculated by multiplying the difference between the actually measured value of the ejection characteristic given by applying the first voltage waveform to the second nozzle and the actually measured value of the ejection characteristic given by applying the first voltage waveform to the first nozzle by a predetermined value smaller than one.

10. The voltage waveform adjustment apparatus according to claim 1, wherein execution of the stored instructions further configures the at least one processor to operate as:
a control unit configured to perform control to display information for identifying the nozzles having been determined to have successfully adjusted voltage waveform and the nozzles determined to have failed the voltage waveform adjustment.

11. A voltage waveform adjustment system comprising:
the voltage waveform adjustment apparatus according to claim 1; and
a liquid ejection apparatus including a liquid ejection head having a nozzle that ejects a droplet upon application of a voltage waveform,
wherein the voltage waveform adjustment apparatus transmits an ejection instruction to the liquid ejection apparatus and receives a measurement result from the liquid ejection apparatus to adjust the voltage waveform to be applied to the nozzle of the liquid ejection head in the liquid ejection apparatus.

12. A processing method by a voltage waveform adjustment apparatus for adjusting a voltage waveform used to drive a first nozzle and a second nozzle each ejecting liquid, the method comprising:
acquiring an amount of displacement representing an amount of shift in the ejection characteristic between the first nozzle and the second nozzle;
storing a first nozzle model, which is a model that estimates a target ejection characteristic, which is an ejection characteristic targeted by a droplet ejected from the second nozzle, and an ejection characteristic of the droplet ejected upon application of the voltage waveform to the first nozzle; and
determining the voltage waveform to be applied to the second nozzle using the stored first nozzle model based on the acquired amount of displacement and the stored target ejection characteristic.
